(19) United States
(12) Patent Application Publication
(10) Pub. No.: US 2026/0348737 A1
(43) Pub. Date: Nov. 5, 2026

(54) GENERATING ROUTES ASSOCIATED WITH BUFFER AREAS

(71) Applicant: International Business Machines Corporation, Armonk, NY (US)

(72) Inventors: Rajesh M. DESAI, San Jose, CA (US); Dorian Boris MILLER, Saratoga, CA (US); Ziyan TU, San Jose, CA (US); Vamshi Krishna THOTEMPUDI, Bothell, WA (US)

(21) Appl. No.: 19/197,632

(22) Filed: May 2, 2025

(51) Int. Cl. G01C 21/36; G01C 21/34

(52) U.S. Cl. CPC G01C 21/3617; G01C 21/3415; G01C 21/3492; G01C 21/362

(57) ABSTRACT

In some implementations, a server may receive a request to register an event. The request may include an indication of event information associated with the event. The server may register the event in response to the request. The server may receive an indication of a user interested in attending the event. The indication may include one or more user-specific constraints and location information associated with the user. The server may generate one or more routes to travel to the event based on the event information, the one or more user-specific constraints, and the location information, wherein the one or more routes each include a buffer area in which the user is to wait for a duration of time. The server may transmit an indication of the one or more routes.

### BACKGROUND

This disclosure relates to computing systems, and more specifically, to generating routes associated with buffer areas.

To generate a route for a vehicle a user may use various platforms. These tools enable the route to comprise a starting point, a destination, and optionally, multiple stops along the way to create an optimized route. Some platforms also offer features like real-time traffic updates, toll road information, and even multi-vehicle route planning.

### SUMMARY

Some aspects described herein relate to a method. The method may include receiving, by a server, a request to register an event, where the request includes an indication of event information associated with the event. The method may include registering, by the server, the event in response to the request. The method may include receiving, by the server, an indication of a user interested in attending the event, where the indication includes one or more user-specific constraints and location information associated with the user. The method may include generating, by the server, one or more routes to travel to the event based on the event information, the one or more user-specific constraints, and the location information, where the one or more routes each include a buffer area in which the user is to wait for a duration of time. The method may include transmitting, by the server, an indication of the one or more routes.

Some aspects described herein relate to a computer system. The computer system may include a processor set, one or more computer-readable storage media, and program instructions stored on the one or more computer-readable storage media to cause the processor set to perform operations. The operations may include receiving an indication of event information associated with an event. The operations may include receiving an indication of location information associated with a vehicle traveling to the event. The operations may include generating one or more routes for the vehicle to travel to the event based on the event information and the location information, where the one or more routes each include a buffer area in which the vehicle is to wait for a duration of time. The operations may include transmitting, to a mobile device associated with the vehicle, an indication of the one or more routes, where the indication indicates the duration of time that the vehicle is to wait in the buffer area before continuing to travel toward the event.

Some aspects described herein relate to a computer program product. The computer program product may include one or more computer-readable storage media and program instructions stored on the one or more computer-readable storage media to perform operations. The operations may include receiving an indication of event information. The operations may include receiving an indication of location information associated with a vehicle traveling to an event, where the event information is associated with the event. The operations may include generating one or more routes for the vehicle to travel to the event based on the event information and the location information, where the one or more routes each include a buffer area in which the vehicle is to wait for a duration of time. The operations may include transmitting, to a mobile device associated with the vehicle, an indication of the one or more routes.

### BRIEF DESCRIPTION OF THE DRAWINGS

FIG. 1 is a diagram of an example computing environment for generating routes associated with buffer areas.

FIG. 2 is a diagram of an example of traffic congestion associated with an event.

FIG. 3 is a diagram of an example associated with generating routes associated with buffer areas.

FIG. 4 is a diagram of an example associated with distributing traffic to waiting buffers.

FIG. 5 is a diagram of an example associated with a user mobile application.

FIG. 6 is a diagram of an example associated with adaptive traffic management.

FIG. 7 is a diagram of an example associated with adaptive traffic management.

FIG. 8 is a diagram of an example associated with a simulated model.

FIG. 9 is a diagram of example components of a device associated with generating routes associated with buffer areas.

FIG. 10 is a flowchart of an example process associated with generating routes associated with buffer areas.

### DETAILED DESCRIPTION

The following detailed description of example implementations refers to the accompanying drawings. The same reference numbers in different drawings may identify the same or similar elements.

Large public events, such as concerts and sporting events, often attract thousands of attendees, resulting in significant traffic congestion in surrounding areas. An influx of vehicles may overwhelm local transportation infrastructure, leading to frustration, delays, and decreased air quality. Moreover, event organizers and local authorities may incur substantial costs for traffic management and emergency services. Attendees may rely on digital mapping services to navigate to event locations. However, these services may not account for real-time traffic patterns and specific event-related road closures, which may increase the usage of system resources. For example, increased traffic congestion may result in an increased vehicle usage time, which may waste battery power or fuel for the vehicle. Traffic congestion associated with large public events may result in suboptimal attendee experience (e.g., increased emotional stress), increased battery/fuel consumption of vehicles, and increased costs for event organizers and local authorities.

In some implementations, a server-based system may be employed for managing traffic associated with a large public event. For example, a server may receive a request to register an event. For example, the request may be received from an event manager associated with organizing the event. The request may include an indication of event information associated with the event. The server may register the event in response to the request. The server may receive an indication of a user interested in attending the event. For example, the server may receive the indication from the user that is interested in attending the event, where the indication may be a request from the user to register for the event. The indication may include one or more user-specific constraints and location information associated with the user. The one or more user-specific constraints may include a travel time limit, a travel cost limit, or a preferred mode of transportation. The server may generate one or more routes to travel to the event based on the event information, the one or more user-specific constraints, and the location information. The server may generate the one or more routes based on one or more datasets associated with potential buffer areas, public transportation options, predicted traffic patterns on routes leading to an event location, or historical data. The one or more routes may each include a buffer area in which the user is to wait for a duration of time. The server may transmit an indication of the one or more routes. For example, the server may transmit the indication to a mobile device associated with the user.

In some implementations, the server may receive an indication of event information associated with the event, and an indication of location information associated with a vehicle traveling to the event. The server may generate one or more routes for the vehicle to travel to the event based on the event information and the location information, wherein the one or more routes each include the buffer area in which the vehicle is to wait for a duration of time.

In some implementations, the server may receive an indication of a selected route from the one or more routes and provide information associated with the selected route. The server may detect that the vehicle has entered a buffer area associated with the selected route, determine that the vehicle is ready to exit the buffer area and continue traveling to the event, and transmit an indication for the vehicle to exit the buffer area and proceed to the event. Such determinations may be made based on real-time traffic information associated with one or more routes to the event, a buffer load associated with the buffer area, an amount of time that the vehicle has been in the buffer area, or a round-robin scheduling algorithm.

In some implementations, the server may provide a driving route path for a vehicle to reach a designated parking area within a predetermined distance of an event location. The server may calculate and optimize the route path and minimize distance based on the capacity of parking and road conditions. The server may assign users a place within a queue to the event, where the queue may be based on the calculated and optimized route path. The queue may be associated with a buffer area or a waiting buffer. The server may output monetization incentives to the users to accept and maintain the assigned place within the queue to create the waiting buffer for the vehicles.

In some implementations, the server may receive information about a large event including location and expected attendance. The server may receive information about the traffic conditions of roads leading to the event. The server may dynamically allocate and adjust buffer areas (or buffer zones) for traffic around the event based on crowd density and traffic conditions. The server may direct users to designated buffer areas based on real-time traffic data and event details. The server may provide users with personalized routes to minimize travel time.

In some implementations, the buffer areas may be designated areas where users are able to wait before proceeding to the event. The directing of users to buffer areas may include providing users with information about the location and capacity of the buffer areas. In some implementations, the dynamically allocating and adjusting of buffer areas may be based on predictions of crowd density and traffic conditions using a machine learning model trained on historical data. Model-predicted traffic flows may be used to build an event plan, both from a user perspective and from an event manager perspective. For example, the event plan may indicate how early the user should leave home to reach the event in time. The event plan may also assist the event manager in planning road closures or traffic redirects to users attending the event. In some implementations, the directing of users to buffer areas may include sending notifications to users via a mobile application, where the notifications may include information about the best route to take to the buffer area and the estimated wait time at the buffer area. In some implementations, the buffer areas may be managed by different entities, which may include public transit authorities, private companies, and/or event organizers. The directing of users to buffer areas may include coordinating with the different entities to optimize traffic flow. In some implementations, the providing of personalized routes may include taking into account the user's mode of transportation, which may include driving, public transit, or ride-sharing. In some implementations, the providing of personalized routes may include providing users with options to avoid congested roads or to take alternative modes of transportation. In some implementations, real-time traffic data may be used from sensors and other sources to adjust the buffer areas and optimize traffic flow. In some implementations, machine learning algorithms may be used to predict the behavior of users and adjust the buffer areas and traffic flow accordingly. In some implementations, incentives may be provided to users to use the buffer areas, where the incentives may include discounts or rewards for using public transit or carpooling.

In some implementations, the server may receive real-time traffic data and an event location. The server may dynamically allocate buffer areas based on the real-time traffic data. The server may generate personalized routes for users of the event to optimize travel time and minimize congestion. The server may direct the users to designated buffer areas along the personalized routes. The server may provide real-time updates to the users regarding optimal travel times and routes to the event. In some implementations, the buffer areas may be dynamically allocated based on crowd density and traffic conditions in real-time. In some implementations, the server may generate incentives for the users to use specific buffer areas or routes, such as discounts or rewards. In some implementations, the server may integrate with public transit systems to optimize travel times and routes for users using public transportation. In some implementations, the server may provide real-time updates to event managers and buffer area providers regarding crowd density and traffic conditions.

In some implementations, the server may dynamically allocate and adjust buffer areas for directing users to alleviate traffic congestion on roads leading to a large in-person event, which may be based on real-time traffic data and crowd density. The server may assign a personalized route to a user based on the user's location, real-time traffic conditions, and the dynamically allocated buffer areas. The server may provide the personalized route to the user through a mobile application. In some implementations, the server may track the user's location and adjust the personalized route in real-time based on changes in traffic conditions and crowd density. In some implementations, the server may provide incentives to the user for taking a specific route or using a specific mode of transportation. The server may enforce compliance with the assigned route or mode of transportation through a system of rewards or penalties. In some implementations, the buffer areas may include public places such as shopping malls, businesses, and public transit stations. The server may direct users to these buffer areas to alleviate congestion on roads leading to the event. In some implementations, the server may use machine learning algorithms to model traffic patterns and crowd behavior. The server may adjust the buffer areas and personalized routes based on real-time data.

In some implementations, by employing traffic management, the server may reduce the amount of resources (e.g., battery power or fuel) consumed by vehicles traveling to the event. The server may optimize network bandwidth usage by distributing traffic management computations across multiple server nodes, conserving processing resources that would have otherwise been consumed by complex routing computations. The server may reduce latency associated with traffic routing by leveraging real-time traffic information and buffer area loads, and minimize the number of network requests by providing optimized routes to vehicles. In addition, the server may conserve processing resources, memory resources, and/or network resources by minimizing the impact of event-related traffic congestion.

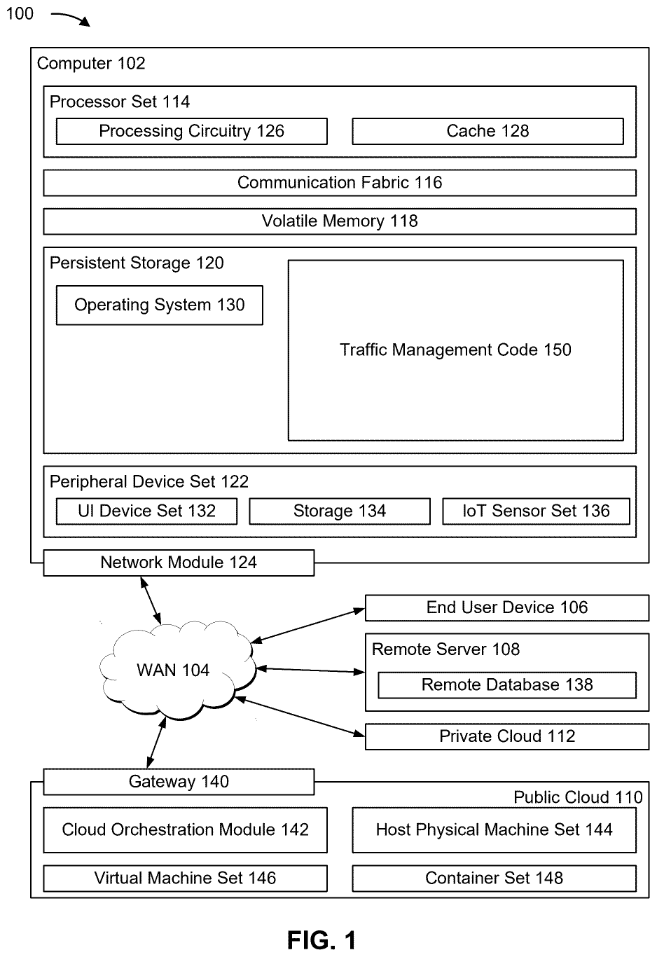

FIG. 1 is a diagram of an example computing environment 100 for generating routes associated with buffer areas.

The computing environment 100 contains an example of an environment for the execution of at least some of the computer code involved in performing the inventive methods, such as traffic management code 150. In addition to the traffic management code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the traffic management code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in traffic management code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the traffic management code 150 typically includes at least some of the computer code involved in performing one or more operations described herein. The operations may include, for example, receiving an indication of event information associated with an event; receiving indication of location information associated with a vehicle traveling to the event; generating one or more routes for the vehicle to travel to the event based on the event information and the location information, wherein the one or more routes each include a buffer area in which the vehicle is to wait for a duration of time; and transmitting an indication of the one or more routes.

In some implementations, the operations may include, for example, receiving an indication of event information associated with an event; receiving an indication of location information associated with a vehicle traveling to the event; generating one or more routes for the vehicle to travel to the event based on the event information and the location information, wherein the one or more routes each include a buffer area in which the vehicle is to wait for a duration of time; and transmitting, to a mobile device associated with the vehicle, an indication of the one or more routes, wherein the indication indicates the duration of time that the vehicle is to wait in the buffer area before continuing to travel toward the event.

In some implementations, the operations may include, for example, receiving an indication of event information; receiving an indication of location information associated with a vehicle traveling to an event, wherein the event information is associated with the event; generating one or more routes for the vehicle to travel to the event based on the event information and the location information, wherein the one or more routes each include a buffer area in which the vehicle is to wait for a duration of time; and transmitting, to a mobile device associated with the vehicle, an indication of the one or more routes.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1), private cloud 112, and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

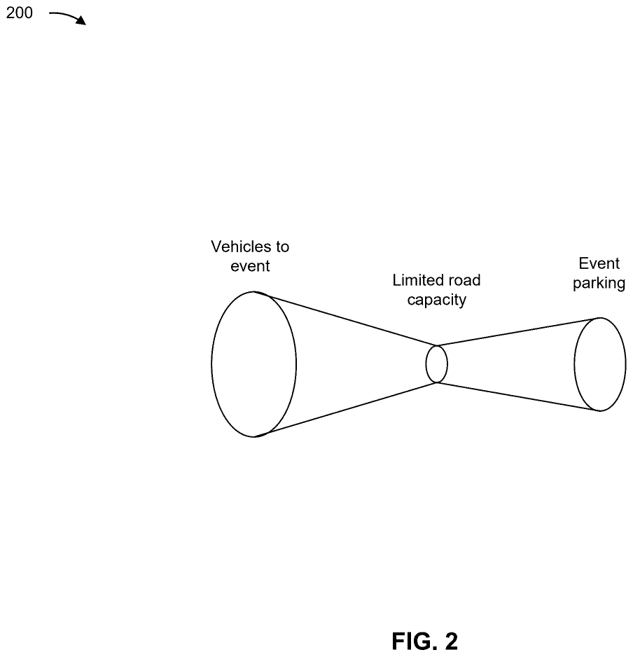

FIG. 2 is a diagram of an example 200 of traffic congestion associated with an event.

As shown in FIG. 2, an event (e.g., a stadium event) may be associated with traffic congestion. A plurality of vehicles may be traveling to the event. The plurality of vehicles may travel on roads associated with a limited road capacity. The plurality of vehicles may travel to a parking area (e.g., stadium parking) associated with the event. Due to limited roads and/or parking, the plurality of vehicles may be associated with the traffic congestion. The plurality of vehicles may also travel at approximately the same time (e.g., which may be due to an event start time), which may further increase the traffic congestion.

FIG. 2 is provided as an example. Other examples may differ from what is described with regard to FIG. 2.

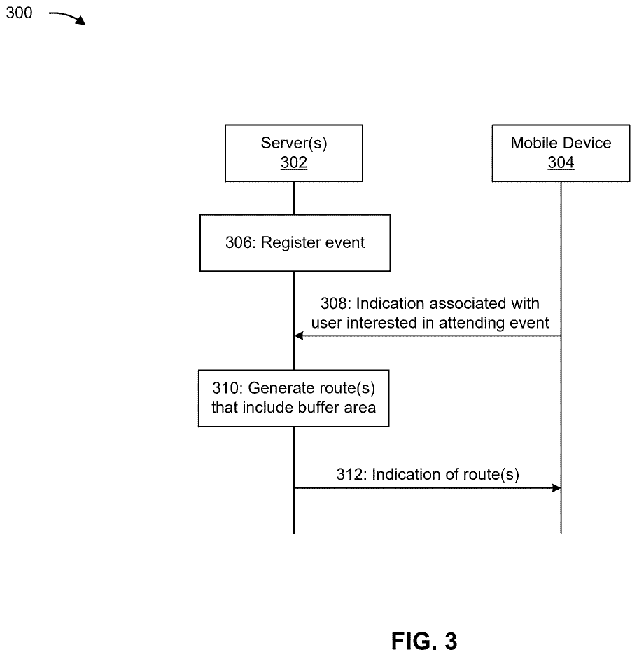

FIG. 3 is a diagram of an example 300 associated with generating routes associated with buffer areas. The example 300 includes a server 302 (or multiple servers) and a mobile device 304.

As shown by reference number 306, the server 302 may register an event. The server 302 may receive a request to register the event. For example, the server 302 may receive the request from an entity associated with an event manager. The request may include an indication of event information associated with the event. The server 302 may register the event in response to the request. In some implementations, the server 302 may identify the event information associated with the event. The event information may include a location associated with the event. The event information may include a time associated with the event. The time may include a start time, an end time, and/or a duration of the event. The event information may include a type of event (e.g., sporting event, a concert, or another type of event). The event information may include information regarding a venue associated with the event. For example, the venue may be a stadium, a concert hall, or another type of venue. The event information may include a number of people that are expected to attend the event. The event information may include a number of vehicles that are expected to drive to the event, where the number of vehicles may be based on the number of people.

As shown by reference number 308, the server 302 may receive, from the mobile device 304 or from another entity, an indication of a user interested in attending the event. The indication may include one or more user-specific constraints and location information associated with the user. The one or more user-specific constraints may include a travel time limit, a travel cost limit, and/or a preferred mode of transportation. The server 302 may receive, from the mobile device 304 or from another entity, an indication of the location information associated with the user or a vehicle associated with the user traveling to the event. The user may be an owner of the vehicle or an event participant (e.g., a person that is attending the event) that is traveling in the vehicle. The user may be associated with the mobile device 304. For example, the user may be carrying the mobile device 304. The location information may include a starting point of the vehicle (e.g., a home address).

As shown by reference number 310, the server 302 may generate one or more routes to travel to the event based on the event information, the one or more user-specific constraints, and the location information. The server 302 may generate the one or more routes based on one or more datasets associated with potential buffer areas, public transportation options, predicted traffic patterns on routes leading to an event location, or historical data. Predictive models may utilize the datasets to provide accurate travel plans, which may include buffer zone details and other pertinent information. The user may being a journey according to a planned travel route and itinerary. The one or more routes may include a buffer area in which the user is to wait for a duration of time. The buffer area may be a parking area associated with a business entity (e.g., a grocery store parking lot or a retail store parking lot). The buffer area may be enroute to the event. The buffer area may be selected from a plurality of different buffer areas that are available to the vehicle. The buffer area may be selected based on a location of the buffer area in relation to the starting location of the vehicle. The buffer area may be selected based on a distance between the buffer area and the starting location of the vehicle. For example, the server 302 may select a buffer area that is closer to the starting location in relation to other buffer areas. The buffer area may be selected based on a current load associated with the buffer area. For example, the server 302 may select a buffer area that has sufficient capacity to handle additional vehicles, as compared to other buffer areas. In other words, the buffer area may be selected based on a current number of vehicles in the buffer area. The server 302 may generate different potential routes, where each potential route may have at least one buffer area. The buffer area may be selected based on a time slot associated with the vehicle. Different vehicles may be assigned with different time slots to manage traffic, so that depending on a specific time slot assigned to the vehicle, an appropriate buffer area may be allocated to the vehicle.

As shown by reference number 312, the server 302 may transmit, to the mobile device 304, an indication of the one or more routes. For example, the indication may include a first route that includes a first buffer area, a second route that includes a second buffer area, and a third route that includes a third buffer area. The indication may indicate the duration of time that the vehicle is to wait in the buffer area before continuing to travel toward the event. In some implementations, the server 302 may receive, from the mobile device 304, an indication of a selected route from the one or more routes. The server 302, after receiving the indication of the selected route, may provide information associated with the selected route to the mobile device 304. For example, the server 302 may provide directions associated with the selected route. The server 302 may provide real-time traffic information associated with the selected route. The server 302 may provide an estimated arrival time at the buffer area, which may be based on the real-time traffic information.

In some implementations, the server 302 may identify buffer area capacity information associated with a plurality of buffer areas. The buffer area capacity information may provide a real-time indication of a buffer area capacity for each of the plurality of buffer areas. For example, the buffer area capacity information may indicate that a first buffer area is 90% full, a second buffer area is 50% full, and so on. The buffer area capacity information may be periodically updated or updated in real-time. The one or more routes that include the buffer area may be based on the buffer area capacity information.

In some implementations, the server 302 may detect that the vehicle has entered a buffer area associated with the selected route. The server 302 may detect that the vehicle has entered the buffer area based on real-time location information provided by the mobile device 304. In some implementations, the server 302 may receive, from the mobile device 304 or from another entity, vehicle information associated with the vehicle. The vehicle information may include an identifier associated with the vehicle. The identifier may be a license plate number. The server 302 may receive, from a computing device associated with the buffer area, a notification that the vehicle has entered the buffer area. The notification may include the identifier associated with the vehicle. A verification that the vehicle has entered the buffer area may be based on the vehicle information. In other words, the server 302 may match the vehicle associated with the notification to the vehicle associated with the vehicle information.

In some implementations, the server 302 may determine that the vehicle is ready to exit the buffer area and continue traveling to the event. The server 302 may transmit, to the mobile device 304, an indication for the vehicle to exit the buffer area and proceed to the event. The vehicle may be ready to exit the buffer area and continue traveling to the event based on a buffer load associated with the buffer area. When the buffer load exceeds a threshold (e.g., the buffer area becomes nearly full of vehicles), the vehicle may be directed to exit the buffer area. The vehicle may be ready to exit the buffer area and continue traveling to the event based on real-time traffic information associated with one or more routes to the event. When traffic associated with the one or more roads has decreased, in relation to a previous point in time, the vehicle may be directed to exit the buffer area. The vehicle may be ready to exit the buffer area and continue traveling to the event based on an amount of time that the vehicle has been in the buffer area. When the amount of time exceeds a threshold, or when the amount of time exceeds an amount of time associated with other vehicles in the buffer area, the vehicle may be directed to exit the buffer area. The vehicle may be ready to exit the buffer area and continue traveling to the event based on a round-robin scheduling algorithm. Each vehicle in each buffer area may be directed to exit a respective buffer area one-by-one or in groups. In some cases, other appropriate scheduling algorithms may be used to direct different vehicles in different buffer areas to the event.

In some implementations, the server 302 may identify a first buffer area. At a later point in time, the server 302 may determine that the first buffer area is associated with a buffer load that exceeds a first threshold based on real-time buffer area information. In other words, the first buffer area may nearly be full of vehicles. Alternatively, the server 302 may determine that the first buffer area is associated with an amount of traffic congestion that exceeds a second threshold based on real-time traffic information. The server 302 may identify a second buffer area that is available to the vehicle based on real-time information. The real-time information may include a current load associated with the second buffer area and/or a current traffic load associated with the second buffer area. The server 302 may transmit, to the mobile device 304, an updated route to the event that includes the second buffer area. In this example, the vehicle may be directed to the second buffer area instead of the first buffer area. Further, a duration of time that the vehicle is to wait in the second buffer area may be different than the duration of time that the vehicle was originally scheduled to wait in the first buffer area.

FIG. 3 is provided as an example. Other examples may differ from what is described with regard to FIG. 3.

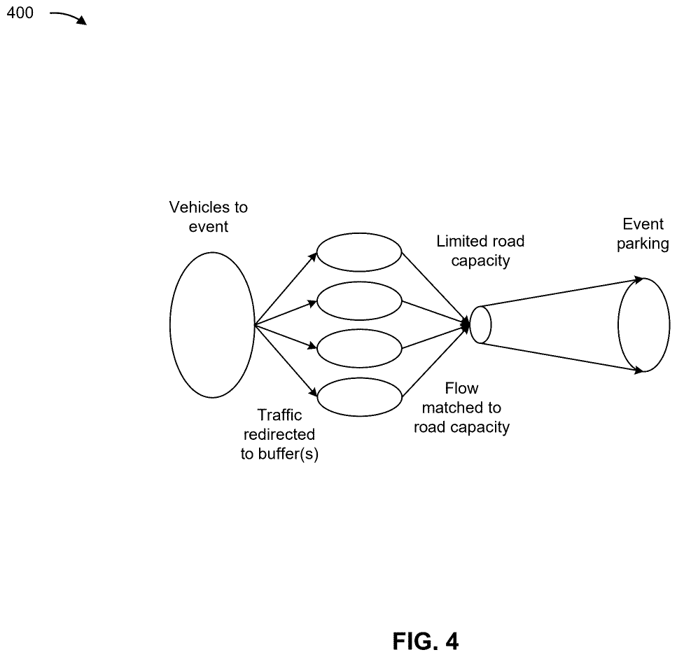

FIG. 4 is a diagram of an example 400 associated with distributing traffic to waiting buffers.

As shown in FIG. 4, a plurality of vehicles may be traveling to an event (e.g., a stadium event). The plurality of vehicles may travel on roads associated with a limited road capacity. The plurality of vehicles may travel to a parking area (e.g., stadium parking) associated with the event. In order to reduce traffic congestion due to limited roads and/or parking, the plurality of vehicles may be directed to one or more waiting buffers. In other words, traffic may be redirected or distributed to the one or more waiting buffers. A waiting buffer may be a buffer for driving participants. The waiting buffer may include a business parking area (e.g., mall parking area, retail store parking area, or grocery store parking area). The waiting buffer may be associated with public transit. For example, the waiting buffer may be an area associated with a park and ride. For example, a user may travel in a vehicle to the area, and then the user may take public transportation. The plurality of vehicles may be directed to the one or more waiting buffers. Each vehicle in the plurality of vehicles may be assigned to a specific waiting buffer of the one or more waiting buffers. After a certain amount of time of waiting at the specific waiting buffer, the vehicle may be directed to the event, such that a flow may be matched to a road capacity. In other words, different vehicles from different waiting buffers may be directed to the event one-by-one or in groups in a manner that matches the limited road capacity, thereby reducing the traffic congestion because not all vehicles may travel at the same time to the event.

In some implementations, system actors may include event participants traveling to the event. The event participants may be associated with the plurality of vehicles. The system actors may include buffer providers. The buffer providers may be associated with the one or more waiting buffers. The buffer providers may include vendors attracting visitors. The system actors may include an event manager. The event manager may be an organizer of the event.

In some implementations, an ability to distribute the traffic to the one or more waiting buffers may provide various benefits to the system actors. The event participants may be provided with efficient travel based on cost and time, assistance with planning, system suggestions which may expand considerations, and/or incentives provided by the buffer providers. The event manager may be provided with an offloaded burden of extra event planning and/or pre-planning based on a simulation of travel capacity. The buffer providers may be provided with increased visitors (e.g., visitors may be drawn to a venue). A public transit utilization may be increased and travelers may be informed about riding.

FIG. 4 is provided as an example. Other examples may differ from what is described with regard to FIG. 4.

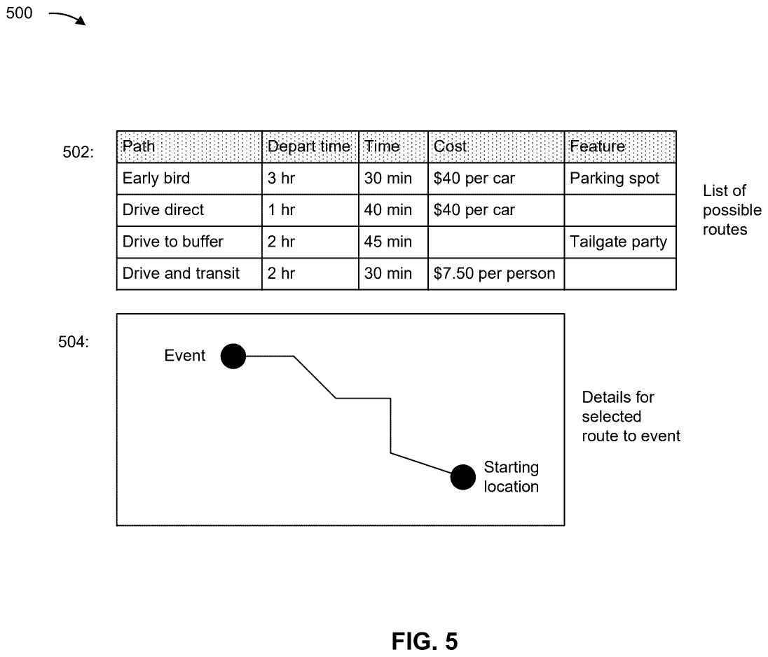

FIG. 5 is a diagram of an example 500 associated with a user mobile application.

As shown by reference number 502, the user mobile application may provide a list of possible routes. Each route may be associated with a path, a depart time, a travel time, a cost, and/or a feature. A first route may be associated with an early bird path, a depart time of 3 hours before an event start time, a travel time of 30 minutes, a cost of $40 per car, and a feature of a parking spot. The first route may involve a vehicle associated with an event participant traveling to the parking spot without any waiting buffer. A second route may be associated with a drive direct path, a depart time of 1 hour before the event start time, a travel time of 40 minutes, and a cost of $40 per car. The second route may involve a vehicle associated with an event participant traveling to an event without any waiting buffer. A third route may be associated with a drive-to-buffer path, a depart time of 2 hours before the event start time, a travel time of 45 minutes, and a feature of a tailgate party. The third route may involve a vehicle associated with an event participant traveling to a waiting buffer prior to traveling to the event. A fourth route may be associated with a drive and transit path, a depart time of 2 hours before the event start time, a travel time of 30 minutes, and a cost of $7.50 per person. The fourth route may involve a vehicle associated with an event participant traveling to a public transit location, at which point the event participant may take public transportation to the event.

As shown by reference number 504, depending on a user selection via the user mobile application, information for a selected route may be provided. The information may include map information and/or driving directions to the event in accordance with the selected route. For example, the information may be associated with the early bird path, the drive direct path, the drive-to-buffer path, or the drive and transit path.

FIG. 5 is provided as an example. Other examples may differ from what is described with regard to FIG. 5.

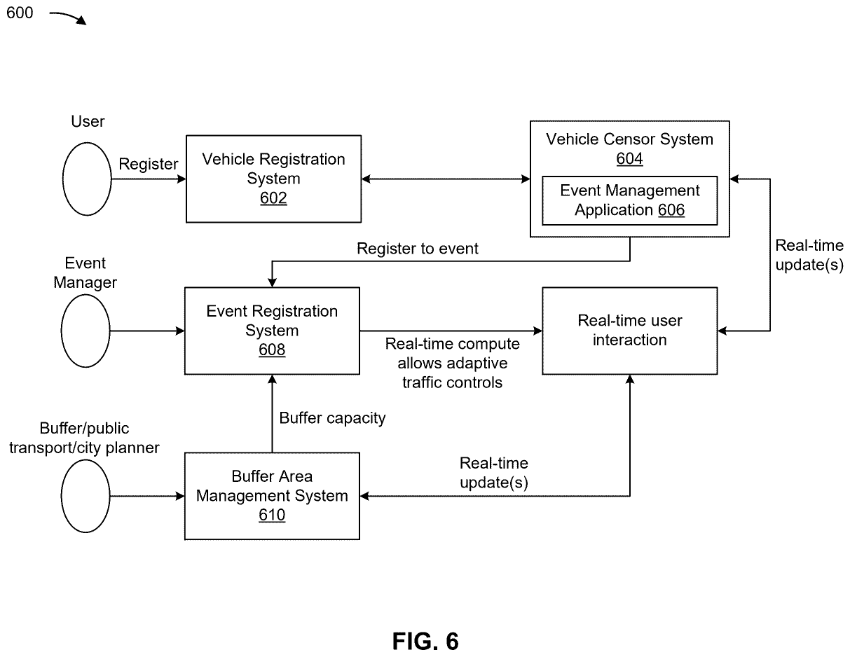

FIG. 6 is a diagram of an example 600 associated with adaptive traffic management. Example 600 includes a vehicle registration system 602, a vehicle censor system 604, an event management application 606, an event registration system 608, and a buffer area management system 610.

In some implementations, adaptive traffic management may be employed to efficiently manage planned events and optimally manage constraint resources. The vehicle registration system 602 may be associated with a user associated with a vehicle traveling to an event. The user may be an owner or an event participant associated with the vehicle. The user may register the vehicle with the vehicle registration system 602. The vehicle registration system 602 may maintain a vehicle database, which may include vehicle information associated with a plurality of vehicles. In some implementations, the vehicle censor system 604 may be associated with a mobile device or the vehicle (e.g., a smart vehicle). The user may be associated with the mobile device. For example, the user may be carrying the mobile device. Alternatively, the user may be riding in the vehicle.

In some implementations, the event registration system 608 may be associated with an event manager. The event registration system 608 may store various types of information, such as event information, venue information, registration information for each event, and/or information regarding real-time monitored events. The user, via the vehicle censor system 604 and/or the event management application 606, may register for the event (e.g., an event that has already been created using the event registration system 608). During a registration, the user may enter information regarding the event via the vehicle censor system 604 and/or the event management application 606. The event may be registered on the event registration system 608. In some implementations, the buffer area management system 610 may be associated with a buffer/public transport/city planner. The buffer area management system 610 may store various types of information, such as parking lot information, open parking space information, and/or public transport information. The parking lot information and/or the open parking space information may be leveraged for parking. The buffer area management system 610 may provide buffer capacity information to the event registration system 608. The buffer capacity information may indicate a capacity of a specific parking lot or a capacity of another open parking area. The buffer area management system 610 may provide the buffer capacity information as a real-time update.

In some implementations, the event registration system 608 may perform a real-time computation, which may allow for adaptive traffic control and real-time user interaction. The adaptive traffic control may be based on real-time updates from the buffer area management system 610. The event registration system 608 may provide real-time updates to the vehicle censor system 604 and/or the event management application 606. The real-time updates may include alerts (e.g., feedback to users), real-time buffer updates, time estimates, and/or checking out options (e.g., checking out of a buffer area to travel to the event).

In some implementations, the vehicle censor system 604 and/or the event management application 606 may support communications involving the owner or the event participant. The real-time user interaction may support indicating dynamic plan changes. The adaptive traffic controls may factor latest conditions during traveling to the event or from the event. The adaptive traffic controls may allow for trip planning to the event or from the event.

In some implementations, a model may be employed to predict different resource capacities, such as buffer areas (e.g., parking lots or public transport), where an output may be stored for each venue and predefined time slot. Input data sources may be associated with the event registration system 608 and the buffer area management system 610. Input data associated with the event registration system 608 may include the event information, the venue information, the registration information for each event, and/or the information regarding real-time monitored events. Input data associated with the buffer area management system 610 may include the parking lot information, the open parking space information, and/or the public transport information. The model may be periodically rebuilt or updated with event updates. The model may build, for each venue and time slot, a proposed plan for capacity resources. A post-processing may involve planning for a given event, venue, and time slot (e.g., for start and end). The post-processing may involve using the proposed plan for the model that maps to an actual user and vehicle. The post-processing may involve an interaction between event user information and real-time user interaction. Model data may be stored for each venue and time slot.

FIG. 6 is provided as an example. Other examples may differ from what is described with regard to FIG. 6.

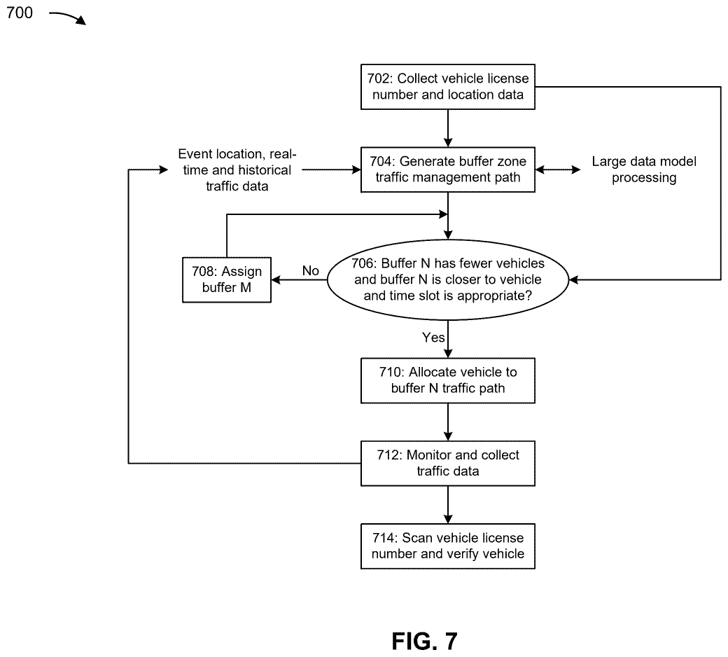

FIG. 7 is a diagram of an example 700 associated with adaptive traffic management.

In some implementations, an event registration system (e.g., as shown in FIG. 6) may be responsible for real-time computing that allows for adaptive traffic controls. The event registration system may be responsible for trip planning, which may be based on a real-time interaction with a mobile device. As shown by reference number 702, the event registration system may collect license number and location information of a vehicle. The vehicle may be associated with a user, who may be an owner of the vehicle or an event participant that is attending an event. The event registration system may associate a vehicle entry pass with a license number. As shown by reference number 704, the event registration system may generate a buffer area traffic management path. The buffer area traffic management path may be generated in order to assign a traffic path for the user. The event registration system may generate the buffer area traffic management path using an event location, historical traffic data, and/or real-time traffic data along with vehicle information. The event registration system may utilize a large data model to generate the buffer area traffic management path. A large data model processing may be utilized to model traffic conditions.

As shown by reference number 706, the event registration system may determine whether buffer N has fewer vehicles in relation to other buffers, buffer N is closer to the vehicle in relation to other buffers, and a time slot for the vehicle is appropriate. As shown by reference number 708, when buffer N does not have less vehicles in relation to other buffers, buffer N is not closer to the vehicle in relation to other buffers, and/or the time slot for the vehicle is not appropriate, the event registration system may assign buffer M to the vehicle. Buffer M may refer to a specific buffer area (e.g., parking area), which may be different from buffer N. As shown by reference number 710, when buffer N does have less vehicles in relation to other buffers, buffer N is closer to the vehicle in relation to other buffers, and/or the time slot for the vehicle is appropriate, the event registration system may allocate the vehicle to the buffer N traffic path. In other words, the event registration system may utilize the large data model to generate a buffer N traffic path. The buffer N traffic path may be a traffic path that is associated with buffer N. The buffer N traffic path may result in a provision of a buffer N parking space before traveling to the event.

As shown by reference number 712, the event registration system may monitor and collect traffic data. The event registration system may modify the traffic path of the vehicle in real-time based on the traffic data. For example, the buffer N traffic path may be adjusted based on live traffic or to handle an emergency, in which case the vehicle may be directed to another buffer area. As shown by reference number 714, after reaching the buffer N parking space, the vehicle may be processed to the event with an automatic scanning of the vehicle license number. In other words, the vehicle license number may be scanned, and the vehicle license number may be verified at an entry pass (e.g., when the vehicle enters buffer N).

FIG. 7 is provided as an example. Other examples may differ from what is described with regard to FIG. 7.

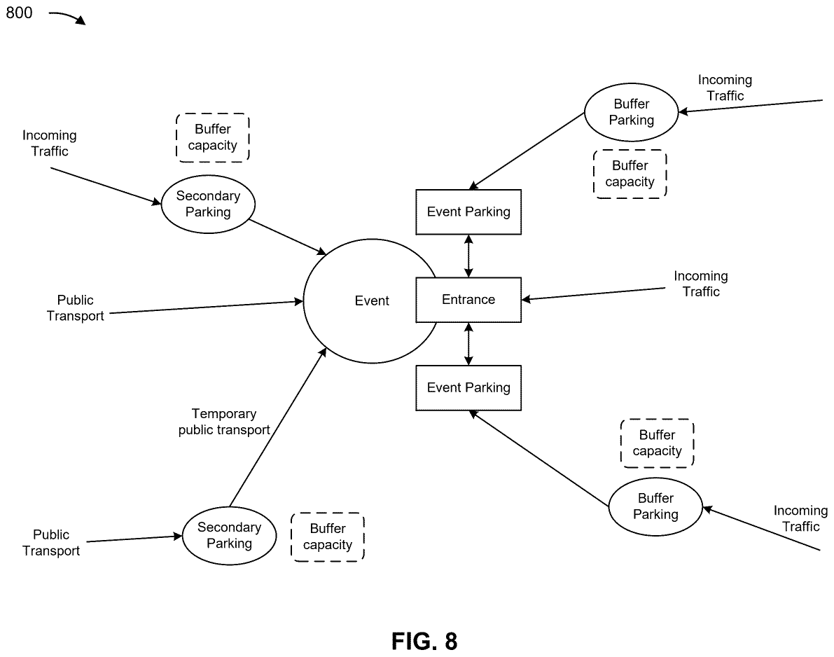

FIG. 8 is a diagram of an example 800 associated with a simulated model.

As shown in FIG. 8, the simulated model may show an event, one or more event parking areas, one or more secondary parking areas, and one or more buffer areas. The simulated model may show incoming traffic to the event, the one or more event parking areas, the one or more secondary parking areas, and/or the one or more buffer areas. The simulated model may show public transport to the event. The simulated model may show real-time traffic. The simulated model may show a buffer capacity and/or a real-time buffer status for the one or more buffer areas. In some implementations, a vehicle may be directed to the event directly. The vehicle may be directed to one of the event parking areas. The vehicle may be directed to one of the secondary parking areas. The vehicle may be directed to one of the buffer areas, and then the vehicle may be directed to one of the event parking areas.

FIG. 8 is provided as an example. Other examples may differ from what is described with regard to FIG. 8.

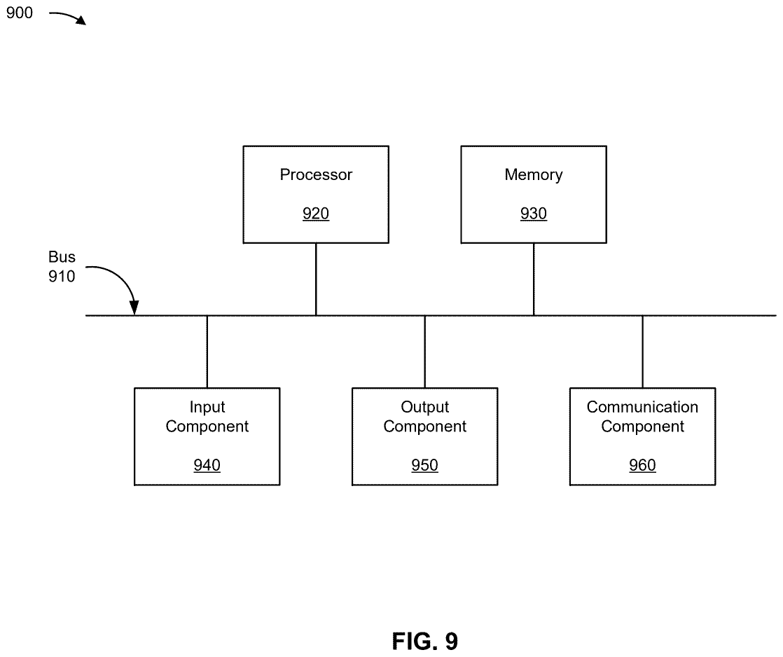

FIG. 9 is a diagram of example components of a device 900 associated with generating routes associated with buffer areas. The device 900 corresponds to one or more of a server (e.g., server 302) and/or a mobile device (e.g., mobile device 304). In some implementations, the server and/or the mobile device include one or more devices 900 and/or one or more components of the device 900. In the example shown in FIG. 9, the device 900 includes a bus 910, a processor 920, a memory 930, an input component 940, an output component 950, and/or a communication component 960.

The bus 910 includes one or more components that enable wired and/or wireless communication among the components of the device 900. The bus 910 couples together two or more components of FIG. 9, such as via operative coupling, communicative coupling, electronic coupling, and/or electric coupling. For example, the bus 910 may include an electrical connection (e.g., a wire, a trace, and/or a lead) and/or a wireless bus. The processor 920 includes a central processing unit, a graphics processing unit, a microprocessor, a controller, a microcontroller, a digital signal processor, a field-programmable gate array, an application-specific integrated circuit, and/or another type of processing component. The processor 920 may be implemented in hardware, firmware, or a combination of hardware and software. In some implementations, the processor 920 includes one or more processors capable of being programmed to perform one or more operations or processes described elsewhere herein.

The memory 930 includes volatile and/or nonvolatile memory, such as random access memory (RAM), read only memory (ROM), a hard disk drive, and/or another type of memory (e.g., a flash memory, a magnetic memory, and/or an optical memory). The memory 930 may include internal memory (e.g., RAM, ROM, or a hard disk drive) and/or removable memory (e.g., removable via a universal serial bus connection). In some implementations, the memory 930 is a non-transitory computer-readable medium. The memory 930 stores information, one or more instructions, and/or software (e.g., one or more software applications) related to the operation of the device 900. In some implementations, the memory 930 includes one or more memories that are coupled (e.g., communicatively coupled) to one or more processors (e.g., processor 920), such as via the bus 910. Communicative coupling between a processor 920 and a memory 930 enables the processor 920 to read and/or process information stored in the memory 930 and/or to store information in the memory 930.

The input component 940 enables the device 900 to receive input, such as user input and/or sensed input. For example, the input component 940 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 950 enables the device 900 to provide output, such as via a display, a speaker, and/or a light-emitting diode. The communication component 960 enables the device 900 to communicate with other devices via a wired connection and/or a wireless connection. For example, the communication component 960 may include a receiver, a transmitter, a transceiver, a modem, a network interface card, and/or an antenna.

In some implementations, the device 900 performs one or more operations or processes described herein. For example, a non-transitory computer-readable medium (e.g., memory 930) may store a set of instructions (e.g., one or more instructions or code) for execution by the processor 920. The processor 920 may execute the set of instructions to perform one or more operations or processes described herein. In some implementations, execution of the set of instructions, by one or more processors 920, causes the one or more processors 920 and/or the device 900 to perform one or more operations or processes described herein. In some implementations, hardwired circuitry is used instead of or in combination with the instructions to perform one or more operations or processes described herein. Additionally, or alternatively, the processor 920 may be configured to perform one or more operations or processes described herein. Thus, implementations described herein are not limited to any specific combination of hardware circuitry and software.

The number and arrangement of components shown in FIG. 9 are provided as an example. The device 900 may include additional components, fewer components, different components, or differently arranged components than those shown in FIG. 9. Additionally, or alternatively, a set of components (e.g., one or more components) of the device 900 may perform one or more functions described as being performed by another set of components of the device 900.

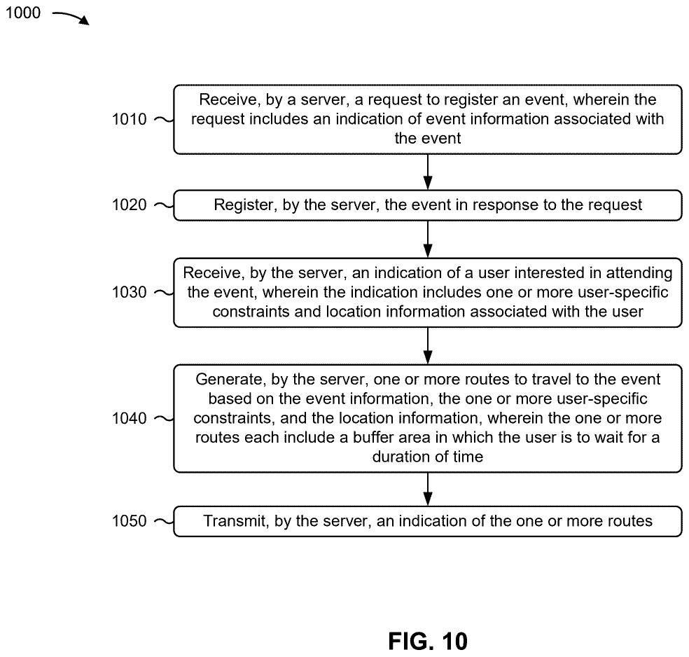

FIG. 10 is a flowchart of an example process 1000 associated with generating routes associated with buffer areas. One or more process blocks of FIG. 10 are performed by a server (e.g., server 302) and/or by another device or a group of devices separate from or including the server, such as a mobile device (e.g., mobile device 304). Additionally, or alternatively, one or more process blocks of FIG. 10 may be performed by one or more components of device 900, such as processor 920, memory 930, input component 940, output component 950, and/or communication component 960.

As shown in FIG. 10, process 1000 includes receiving, by a server, a request to register an event, wherein the request includes an indication of event information associated with the event (block 1010). For example, the server may receive a request to register an event, wherein the request includes an indication of event information associated with the event, as described above.

As further shown in FIG. 10, process 1000 includes registering, by the server, the event in response to the request (block 1020). For example, the server may register the event in response to the request, as described above.

As further shown in FIG. 10, process 1000 includes receiving, by the server, an indication of a user interested in attending the event, wherein the indication includes one or more user-specific constraints and location information associated with the user (block 1030). For example, the server may receive an indication of a user interested in attending the event, wherein the indication includes one or more user-specific constraints and location information associated with the user, as described above.

As further shown in FIG. 10, process 1000 includes generating, by the server, one or more routes to travel to the event based on the event information, the one or more user-specific constraints, and the location information, wherein the one or more routes each include a buffer area in which the user is to wait for a duration of time (block 1040). For example, the server may generate one or more routes to travel to the event based on the event information, the one or more user-specific constraints, and the location information, wherein the one or more routes each include a buffer area in which the user is to wait for a duration of time, as described above.

As further shown in FIG. 10, process 1000 includes transmitting, by the server, an indication of the one or more routes (block 1050). For example, the server may transmit, using the server, an indication of the one or more routes, as described above.

Process 1000 may include additional aspects, such as any single aspect or any combination of aspects described below and/or in connection with one or more other processes described elsewhere herein.

In a first aspect, the one or more user-specific constraints include one or more of: a travel time limit, a travel cost limit, or a preferred mode of transportation.

In a second aspect, alone or in combination with the first aspect, process 1000 includes generating the one or more routes based on one or more datasets associated with potential buffer areas, public transportation options, predicted traffic patterns on routes leading to an event location, or historical data.

In a third aspect, alone or in combination with one or more of the first and second aspects, process 1000 includes receiving, by the server, an indication of a selected route from the one or more routes, and providing, by the server, information associated with the selected route.

In a fourth aspect, alone or in combination with the third aspect, process 1000 includes detecting, by the server, that a vehicle associated with the user has entered a buffer area associated with the selected route, determining, by the server, that the vehicle is to exit the buffer area and continue traveling to the event, and transmitting, by the server, an indication for the vehicle to exit the buffer area and proceed to the event.

In a fifth aspect, alone or in combination with one or more of the first and fourth aspects, the vehicle is to exit the buffer area and continue traveling to the event based on one or more of a buffer load associated with the buffer area, real-time traffic information associated with one or more routes to the event, an amount of time that the vehicle has been in the buffer area, or a round-robin scheduling algorithm.

In a sixth aspect, alone or in combination with one or more of the first through fifth aspects, the buffer area is selected based on one or more of a current number of vehicles in the buffer area, a distance between the buffer area and a starting location of the user, or a time slot associated with the user, and the starting location is indicated in the location information.

In a seventh aspect, alone or in combination with one or more of the first through sixth aspects, the buffer area is a first buffer area, and process 1000 includes determining, by the server, that the first buffer area is associated with a buffer load that exceeds a first threshold based on real-time buffer area information, or that the first buffer area is associated with an amount of traffic congestion that exceeds a second threshold based on real-time traffic information, identifying, by the server, a second buffer area that is available to the user based on real-time information, and transmitting, by the server, an updated route to the event that includes the second buffer area.

In an eighth aspect, alone or in combination with one or more of the first through seventh aspects, process 1000 includes identifying, by the server, buffer area capacity information associated with a plurality of buffer areas, wherein the buffer area capacity information provides a real-time indication of a buffer area capacity for the plurality of buffer areas, and wherein the one or more routes that include the buffer area are based on the buffer area capacity information.

In a ninth aspect, alone or in combination with one or more of the first through eighth aspects, process 1000 includes receiving, by the server, vehicle information associated with a vehicle of the user, wherein the vehicle information includes an identifier associated with the vehicle, and receiving, by the server, a notification that the vehicle has entered the buffer area, wherein a verification that the vehicle has entered the buffer area is based on the vehicle information.

In a tenth aspect, alone or in combination with one or more of the first through ninth aspects, the location information includes a starting location associated with the user, and the event information includes a location associated with the event.

In an eleventh aspect, alone or in combination with one or more of the first through tenth aspects, transmitting the indication comprises transmitting the indication to a mobile device associated with the user.

Although FIG. 10 shows example blocks of process 1000, in some implementations, process 1000 includes additional blocks, fewer blocks, different blocks, or differently arranged blocks than those depicted in FIG. 10. Additionally, or alternatively, two or more of the blocks of process 1000 may be performed in parallel.

In some implementations, the method comprises: receiving, by a server, a request to register an event, wherein the request includes an indication of event information associated with the event; registering, by the server, the event in response to the request; receiving, by the server, an indication of a user interested in attending the event, wherein the indication includes one or more user-specific constraints and location information associated with the user; generating, by the server, one or more routes to travel to the event based on the event information, the one or more user-specific constraints, and the location information, wherein the one or more routes each include a buffer area in which the user is to wait for a duration of time; and transmitting, by the server, an indication of the one or more routes.

In some implementations, the one or more user-specific constraints include one or more of: a travel time limit, a travel cost limit, or a preferred mode of transportation.

In some implementations, generating the one or more routes is based on one or more datasets associated with potential buffer areas, public transportation options, predicted traffic patterns on routes leading to an event location, or historical data.

In some implementations, the method further comprises: receiving, by the server, an indication of a selected route from the one or more routes; and providing, by the server, information associated with the selected route.

In some implementations, the method further comprises: detecting, by the server, that a vehicle associated with the user has entered a buffer area associated with the selected route; determining, by the server, that the vehicle is to exit the buffer area and continue traveling to the event; and transmitting, by the server, an indication for the vehicle to exit the buffer area and proceed to the event.

In some implementations, the vehicle is to exit the buffer area and continue traveling to the event based on one or more of: a buffer load associated with the buffer area, real-time traffic information associated with one or more routes to the event, an amount of time that the vehicle has been in the buffer area, or a round-robin scheduling algorithm.

In some implementations, the buffer area is selected based on one or more of: a current number of vehicles in the buffer area, a distance between the buffer area and a starting location of the user, or a time slot associated with the user, and wherein the starting location is indicated in the location information.

In some implementations, the buffer area is a first buffer area, and the method further comprises: determining, by the server, that the first buffer area is associated with a buffer load that exceeds a first threshold based on real-time buffer area information, or that the first buffer area is associated with an amount of traffic congestion that exceeds a second threshold based on real-time traffic information; identifying, by the server, a second buffer area that is available to the user based on real-time information; and transmitting, by the server, an updated route to the event that includes the second buffer area.

In some implementations, the method further comprises: identifying, by the server, buffer area capacity information associated with a plurality of buffer areas, wherein the buffer area capacity information provides a real-time indication of a buffer area capacity for the plurality of buffer areas, and wherein the one or more routes that include the buffer area are based on the buffer area capacity information.

In some implementations, the method further comprises: receiving, by the server, vehicle information associated with a vehicle of the user, wherein the vehicle information includes an identifier associated with the vehicle; and receiving, by the server, a notification that the vehicle has entered the buffer area, wherein a verification that the vehicle has entered the buffer area is based on the vehicle information.

In some implementations, the location information includes a starting location associated with the user, and the event information includes a location associated with the event.

In some implementations, the method further comprises: transmitting the indication to a mobile device associated with the user.

In some implementations, a computer system comprises: a processor set; one or more computer-readable storage media; and program instructions stored on the one or more computer-readable storage media to cause the processor set to perform operations comprising: receiving an indication of event information associated with an event; receiving an indication of location information associated with a vehicle traveling to the event; generating one or more routes for the vehicle to travel to the event based on the event information and the location information, wherein the one or more routes each include a buffer area in which the vehicle is to wait for a duration of time; and transmitting, to a mobile device associated with the vehicle, an indication of the one or more routes, wherein the indication indicates the duration of time that the vehicle is to wait in the buffer area before continuing to travel toward the event.

In some implementations, the operations further comprise: receiving an indication of a selected route from the one or more routes; and providing information associated with the selected route.

In some implementations, the operations further comprise: detecting that the vehicle has entered a buffer area associated with the selected route; determining that the vehicle is ready to exit the buffer area and continue traveling to the event; and transmitting an indication for the vehicle to exit the buffer area and proceed to the event.

In some implementations, the vehicle is ready to exit the buffer area and continue traveling to the event based on one or more of: a buffer load associated with the buffer area, real-time traffic information associated with one or more routes to the event, an amount of time that the vehicle has been in the buffer area, or a round-robin scheduling algorithm.

In some implementations, the buffer area is selected based on one or more of: a current number of vehicles in the buffer area, a distance between the buffer area and a starting location of the vehicle, or a time slot associated with the vehicle, and the starting location is indicated in the location information.

In some implementations, the buffer area is a first buffer area, and the operations further comprise: determining that the first buffer area is associated with a buffer load that exceeds a first threshold based on real-time buffer area information, or that the first buffer area is associated with an amount of traffic congestion that exceeds a second threshold based on real-time traffic information; identifying a second buffer area that is available to the vehicle based on real-time information; and transmitting an updated route to the event that includes the second buffer area.

In some implementations, the operations further comprise: identifying buffer area capacity information associated with a plurality of buffer areas, wherein the buffer area capacity information provides a real-time indication of a buffer area capacity for the plurality of buffer areas, and wherein the one or more routes that include the buffer area are based on the buffer area capacity information.

In some implementations, the operations further comprise: receiving vehicle information associated with the vehicle, wherein the vehicle information includes an identifier associated with the vehicle; and receiving a notification that the vehicle has entered the buffer area, wherein a verification that the vehicle has entered the buffer area is based on the vehicle information.

In some implementations, the location information includes a starting location associated with the vehicle, and the event information includes a location associated with the event.

In some implementations, a computer program product comprises: one or more computer-readable storage media; and program instructions stored on the one or more computer-readable storage media to perform operations comprising: receiving an indication of event information; receiving an indication of location information associated with a vehicle traveling to an event, wherein the event information is associated with the event; generating one or more routes for the vehicle to travel to the event based on the event information and the location information, wherein the one or more routes each include a buffer area in which the vehicle is to wait for a duration of time; and transmitting, to a mobile device associated with the vehicle, an indication of the one or more routes.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, by a server, a request to register an event, wherein the request includes an indication of event information associated with the event;
registering, by the server, the event in response to the request;
receiving, by the server, an indication of a user interested in attending the event, wherein the indication includes one or more user-specific constraints and location information associated with the user;
generating, by the server, one or more routes to travel to the event based on the event information, the one or more user-specific constraints, and the location information, wherein the one or more routes each include a buffer area in which the user is to wait for a duration of time; and
transmitting, by the server, an indication of the one or more routes.

2. The method of claim 1, wherein the one or more user-specific constraints include one or more of: a travel time limit, a travel cost limit, or a preferred mode of transportation.

3. The method of claim 1, wherein generating the one or more routes is based on one or more datasets associated with potential buffer areas, public transportation options, predicted traffic patterns on routes leading to an event location, or historical data.

4. The method of claim 1, further comprising:
receiving, by the server, an indication of a selected route from the one or more routes; and
providing, by the server, information associated with the selected route.

5. The method of claim 4, further comprising:
detecting, by the server, that a vehicle associated with the user has entered a buffer area associated with the selected route;
determining, by the server, that the vehicle is to exit the buffer area and continue traveling to the event; and
transmitting, by the server, an indication for the vehicle to exit the buffer area and proceed to the event.

6. The method of claim 5, wherein the vehicle is to exit the buffer area and continue traveling to the event based on one or more of: a buffer load associated with the buffer area, real-time traffic information associated with one or more routes to the event, an amount of time that the vehicle has been in the buffer area, or a round-robin scheduling algorithm.

7. The method of claim 1, wherein the buffer area is selected based on one or more of: a current number of vehicles in the buffer area, a distance between the buffer area and a starting location of the user, or a time slot associated with the user, and wherein the starting location is indicated in the location information.

8. The method of claim 1, wherein the buffer area is a first buffer area, and further comprising:
determining, by the server, that the first buffer area is associated with a buffer load that exceeds a first threshold based on real-time buffer area information, or that the first buffer area is associated with an amount of traffic congestion that exceeds a second threshold based on real-time traffic information;
identifying, by the server, a second buffer area that is available to the user based on real-time information; and
transmitting, by the server, an updated route to the event that includes the second buffer area.

9. The method of claim 1, further comprising:
identifying, by the server, buffer area capacity information associated with a plurality of buffer areas, wherein the buffer area capacity information provides a real-time indication of a buffer area capacity for the plurality of buffer areas, and wherein the one or more routes that include the buffer area are based on the buffer area capacity information.

10. The method of claim 1, further comprising:
receiving, by the server, vehicle information associated with a vehicle of the user, wherein the vehicle information includes an identifier associated with the vehicle; and
receiving, by the server, a notification that the vehicle has entered the buffer area, wherein a verification that the vehicle has entered the buffer area is based on the vehicle information.

11. The method of claim 1, wherein the location information includes a starting location associated with the user, and wherein the event information includes a location associated with the event.

12. The method of claim 1, wherein transmitting the indication comprises transmitting the indication to a mobile device associated with the user.

13. A computer system comprising:
a processor set;
one or more computer-readable storage media; and
program instructions stored on the one or more computer-readable storage media to cause the processor set to perform operations comprising:
receiving an indication of event information associated with an event;
receiving an indication of location information associated with a vehicle traveling to the event;
generating one or more routes for the vehicle to travel to the event based on the event information and the location information, wherein the one or more routes each include a buffer area in which the vehicle is to wait for a duration of time; and
transmitting, to a mobile device associated with the vehicle, an indication of the one or more routes, wherein the indication indicates the duration of time that the vehicle is to wait in the buffer area before continuing to travel toward the event.

14. The computer system of claim 13, wherein the operations further comprise:
receiving an indication of a selected route from the one or more routes; and
providing information associated with the selected route.

15. The computer system of claim 14, wherein the operations further comprise:
detecting that the vehicle has entered a buffer area associated with the selected route;
determining that the vehicle is ready to exit the buffer area and continue traveling to the event, wherein the vehicle is ready to exit the buffer area and continue traveling to the event based on one or more of: a buffer load associated with the buffer area, real-time traffic information associated with one or more routes to the event, an amount of time that the vehicle has been in the buffer area, or a round-robin scheduling algorithm; and
transmitting an indication for the vehicle to exit the buffer area and proceed to the event.

16. The computer system of claim 13, wherein the buffer area is selected based on one or more of: a current number of vehicles in the buffer area, a distance between the buffer area and a starting location of the vehicle, or a time slot associated with the vehicle, and wherein the starting location is indicated in the location information.

17. The computer system of claim 13, wherein the buffer area is a first buffer area, and the operations further comprise:
determining that the first buffer area is associated with a buffer load that exceeds a first threshold based on real-time buffer area information, or that the first buffer area is associated with an amount of traffic congestion that exceeds a second threshold based on real-time traffic information;
identifying a second buffer area that is available to the vehicle based on real-time information; and
transmitting an updated route to the event that includes the second buffer area.

18. The computer system of claim 13, wherein the operations further comprise:
identifying buffer area capacity information associated with a plurality of buffer areas, wherein the buffer area capacity information provides a real-time indication of a buffer area capacity for the plurality of buffer areas, and wherein the one or more routes that include the buffer area are based on the buffer area capacity information.

19. The computer system of claim 13, wherein the operations further comprise:
receiving vehicle information associated with the vehicle, wherein the vehicle information includes an identifier associated with the vehicle; and
receiving a notification that the vehicle has entered the buffer area, wherein a verification that the vehicle has entered the buffer area is based on the vehicle information.

20. A computer program product comprising:
one or more computer-readable storage media; and
program instructions stored on the one or more computer-readable storage media to perform operations comprising:
receiving an indication of event information;
receiving an indication of location information associated with a vehicle traveling to an event, wherein the event information is associated with the event;
generating one or more routes for the vehicle to travel to the event based on the event information and the location information, wherein the one or more routes each include a buffer area in which the vehicle is to wait for a duration of time; and
transmitting, to a mobile device associated with the vehicle, an indication of the one or more routes.
